(19) United States
(12) Patent Application Publication
(10) Pub. No.: US 2006/0049763 A1
(43) Pub. Date: Mar. 9, 2006

(54) Structure of flat gas discharge lamp

(75) Inventor: Li-Ren Tsuei, Padeh City (TW)

Correspondence Address: BACON & THOMAS, PLLC, 625 SLATERS LANE, FOURTH FLOOR, ALEXANDRIA, VA, 22314, US

(73) Assignee: ChungHwa Picture Tubes., LTD, Padeh City (TW)

(21) Appl. No.: 10/934,408

(22) Filed: Sep. 7, 2004

(51) Int. Cl. H01J 17/20; H01J 63/04; H01J 17/16; H01J 61/12

(52) U.S. Cl. 313/637; 313/634

(57) ABSTRACT

A flat gas discharge lamp includes a first or lower substrate, a plurality of metal electrodes, a dielectric layer, a second or supper substrate, a grid-mesh-shaped spacer, discharge gas and phosphor. The second substrate is parallel with and at an appropriate distance from the first substrate. The grid-mesh-shaped spacer is provided between the first and second substrates. The grid-mesh-shaped spacer defines many discharge cells. The metal electrodes are provided on the first and second substrates, separately or simultaneously. The dielectric layer is provided on the metal electrodes. The discharge gas is put in the discharge cells.

### BACKGROUND OF THE INVENTION

1. Field of the Invention

The present invention relates generally to a flat lamp, and more particularly to a flat gas discharge lamp with a grid-mesh-shaped spacer.

2. Description of the Related Art

For being able to provide efficient and even illumination over a large area, a flat lamp is often used as a backlight of a liquid crystal display or in other applications. The flat lamp is a plasma illuminative element. It is operated that electrons emitted from a cathode impinge, ionize, and excite inert gas provided between a cathode and an anode inside of a discharge space. Excited atoms in plasma emit ultraviolet light in order to return to the basic status. A layer of phosphor is coated on an internal wall of the flat lamp. The emitted ultraviolet rays excite the phosphor coated on an internal wall of the flat lamp in order to produce visible light.

FIG. 1 shows a conventional flat lamp. This conventional flat lamp includes a gas discharge space 100, phosphor 101, discharge gas 102, metal electrodes 103, spacer 104, and a dielectric layer 105. The gas discharge space 100 includes a transparent substrate 100a, a stripe substrate 100b, and lateral strips 100c between edges of the transparent substrates 100a and the stripe substrates 100b in order to define the closed discharge space 100.

FIGS. 2A to 2E show conventional spacers for flat lamps. They look like a rod (FIG. 2A), a ball (FIG. 2B), a cross (FIG. 2C), a strip (FIG. 2D), or any combination thereof (FIG. 2E).

It is difficult to make the spacers. They provide poor support to the upper and lower substrates. It is also difficult to locate the spacers. The making of the spacers is time-consuming and extensive. Hence, the development and mass production of the spacers are confined. Moreover, cells of the discharge space are not isolated from one another, which causes anions and positive ions affect each other in the cells in an alternating current exchange transformation process.

The present invention is therefore intended to obviate or at least alleviate the problems encountered in prior art.

### SUMMARY OF THE INVENTION

It is an objective of the present invention to provide a structure of flat gas discharge lamp with a grid-mesh-shaped spacer that provides discharge cells with a confined scope in order to reduce the possibility of anions and positive ions affecting each other so as to increase discharge efficiency.

It is another objective of the present invention to provide a structure of flat gas discharge lamp with a grid-mesh-shaped spacer that is made easily, and provides adequate support and is positioned easily in assembling.

It is another objective of the present invention to provide a structure of flat gas discharge lamp with a grid-mesh-shaped spacer that renders possible coating of phosphor on a large area of an internal wall of the flat gas discharge lamp in order to achieve high efficiency in illumination.

According to the present invention, a structure of flat gas discharge lamp includes a first substrate, metal electrodes, a dielectric layer, a phosphor layer, a second substrate, and a grid-mesh-shaped spacer. The second substrate is set to be a light source side and made of a transparent substrate. The metal electrodes are provided on the first and second substrates, separately or simultaneously. The dielectric layer is provided on the metal electrodes. The grid-mesh-shaped spacer defines a plurality of holes and is provided between the first and second substrates. The grid-mesh-shaped spacer defines many discharge cells with a confined scope. Before the flat gas discharge lamp is assembled, a layer of phosphor is coated on the dielectric layer between the first and second substrates. A layer of phosphor can be coated on an internal side of the grid-mesh-shaped spacer in order to increase the area of the layer of phosphor.

Other objects, advantages and novel features of the present invention will become more apparent from the following detailed description referring to the attached drawings.

### BRIEF DESCRIPTION OF THE DRAWINGS

The present invention will be described via detailed illustration of embodiments referring to the drawings.

FIG. 1 is a conventional flat gas discharge lamp;

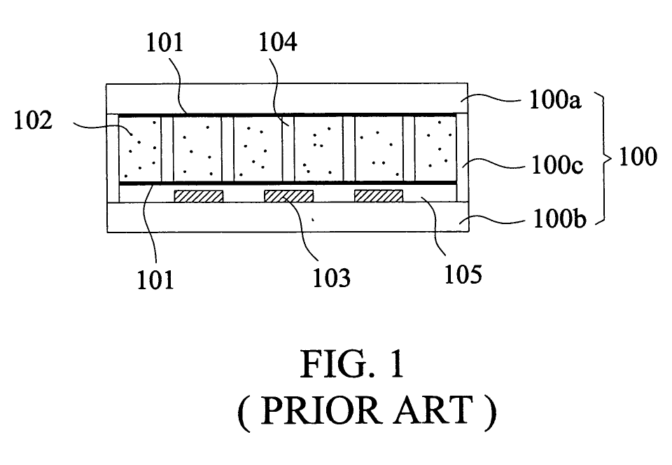

FIGS. 2A to 2E are various spacers of conventional flat gas discharge lamps;

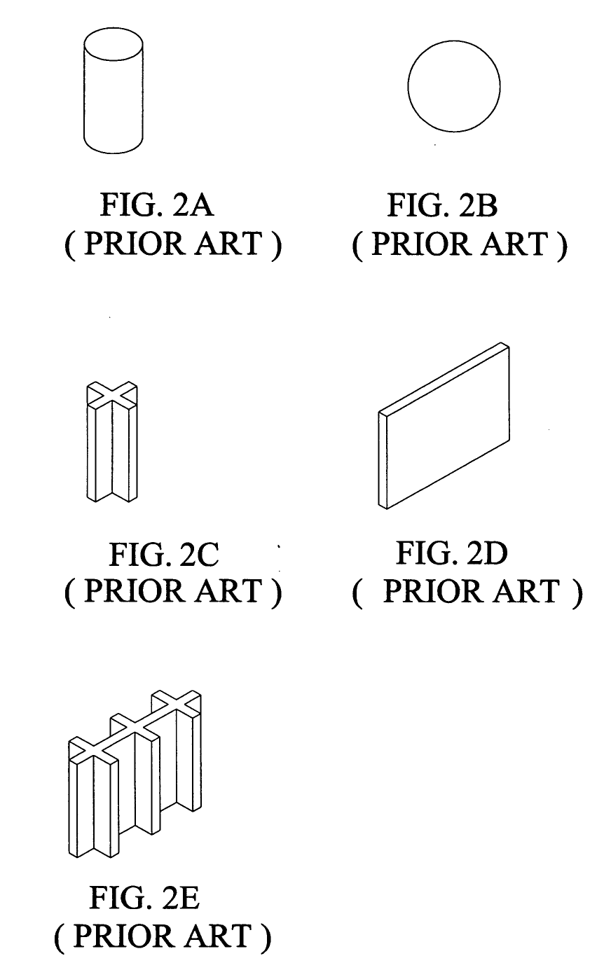

FIG. 3 is a flat gas discharge lamp according to the present invention; and

FIG. 4 is a spacer of the flat gas discharge lamp according to the present invention.

### DESCRIPTION OF THE PREFERRED EMBODIMENTS

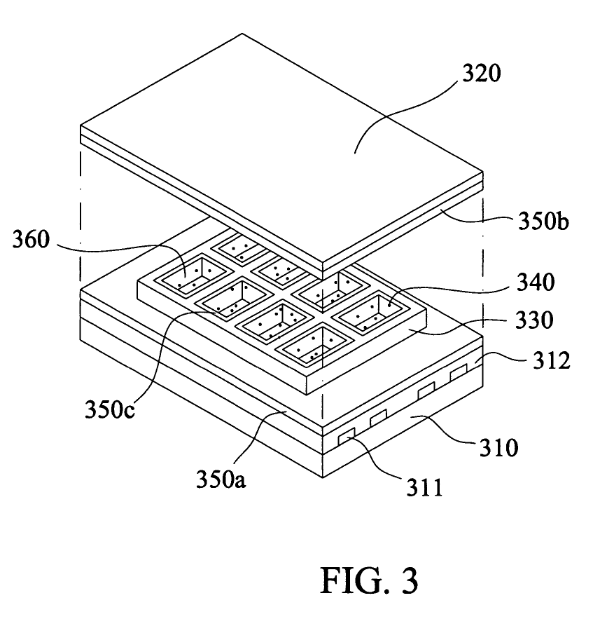

As shown in FIG. 3, according to the present invention, a flat gas discharge lamp includes a first or lower substrate 310, metal electrodes 311, a dielectric layer 312, a second or upper substrate 320, a grid-mesh-shaped spacer 330, discharge gas 340, and phosphorous layers 350a, 350b, and 305c. At least one of the first substrate 310 and the second substrate 320 is made of transparent glass and set to be a light source side. In this embodiment, the second substrate 320 is made of transparent glass. Subsequently, the metal electrodes 311, the dielectric layer 312, and the phosphorous layer 350a are provided on the first substrate 310. The phosphorous layer 350b is coated on a lower side of the second substrate 320. The grid-mesh-shaped spacer 330 is provided between the first substrate 310 and the second substrate 320 so as to define a plurality of discharge cells 360 for containing the discharge gas 340. Helium, neon, argon, krypton, xenon or any mixture thereof may be used as the discharge gas 340.

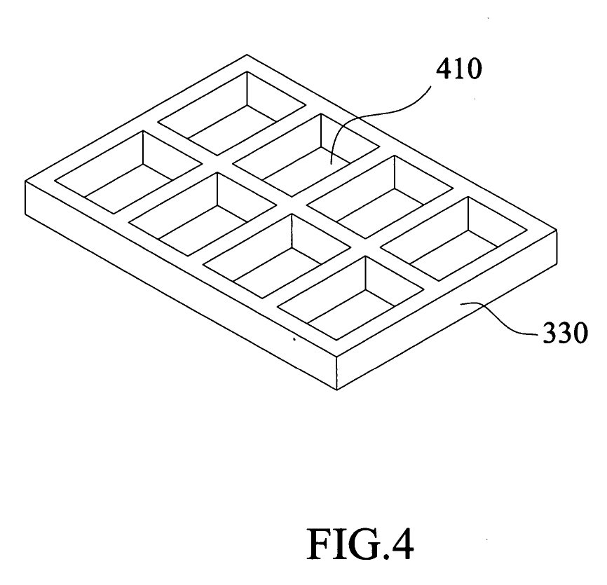

As shown in FIG. 4, the grid-mesh-shaped spacer 330 that is made in the following process. Firstly, a layer of metal, glass, or ceramic with appropriate thickness is provided. Then, holes 410 are evenly defined in this layer by means of etching, cutting, or punching. The holes 410 are rectangular, circular, triangular, hexangular or otherwise appropriately polygonal. Each hole 410 becomes a discharge cell 360.

In the grid-mesh-shaped spacer 330, each hole 410 becomes a discharge cell 360 with a confined scope. Thus, the possibility of anions and positive ions affecting each other in an exchange transformation process is low. Hence, discharge efficiency of the flat gas discharge lamp is high.

Because of simple production of the grid-mesh-shaped spacer 330, the related cost is low. For including a grid-mesh-shaped even distribution, the grid-mesh-shaped spacer 330 provides adequate support to the first substrate 310 and the second substrate 320. In addition, in the assembly of the flat gas discharge lamp, alignment of the first substrate 310 with the second substrate 320 need not be considered. As long as each discharge cell 360 contains at least one metal electrode 311 located on the first substrate 310 to let an electric field penetrate the discharge cell 360, gas discharge can be conducted.

Moreover, because an internal wall of the grid-mesh-shaped spacer 330 is coated with the phosphorous layer 350c, the total area covered by means of the phosphorous layer 350c is large and the efficiency of illumination is therefore high.

The present invention has been described via detailed illustration of some embodiments. Those skilled in the art can derive variations from the embodiments without departing from the scope of the present invention. Therefore, the embodiments shall not limit the scope of the present invention defined in the claims.

What is claimed is:

1. A flat gas discharge lamp comprising:
a first substrate;
a second substrate located parallel with said first substrate, the second substrate being a transparent substrate;
a spacer provided between said first substrate and said second substrate in order to define discharge cells, said spacer defining a plurality of holes;
electrodes provided on said first substrate and said second substrate separately or simultaneously;
a dielectric layer provided on said electrodes;
a layer of phosphor provided on said dielectric layer and on the walls of said holes; and
discharge gas put in said discharge cells.

2. The flat gas discharge lamp according to claim 1 wherein said first substrate and said second substrate include glass.

3. The flat gas discharge lamp according to claim 1 wherein said electrodes include metal electrodes.

4. The flat gas discharge lamp according to claim 3 wherein said electrodes are selected from silver electrodes and copper electrodes.

5. The flat gas discharge lamp according to claim 1 wherein said spacer is made from material included metal, glass, and ceramic.

6. The flat gas discharge lamp according to claim 1 wherein said spacer is made by means of etching, cutting, and punching.

7. The flat gas discharge lamp according to claim 1 wherein said holes formed by said spacer are the same shape and distributed in the spacer evenly.

8. The flat gas discharge lamp according to claim 1 wherein said holes formed by said spacer include rectangular, circular, triangular, hexangular, and polygonal.

9. The flat gas discharge lamp according to claim 1 wherein said holes contains at least one electrode.

10. The flat gas discharge lamp according to claim 1 wherein said discharge cells allow gas discharge to occur therein.

11. The flat gas discharge lamp according to claim 10 wherein said gas discharge can excite said phosphorous layers to emit visible light.

12. The flat gas discharge lamp according to claim 1 wherein said discharge gas includes inert gas.

13. The flat gas discharge lamp according to claim 12 wherein said inert gas includes helium, neon, argon, krypton, xenon, and any mixture thereof.
